(19) United States
(12) Patent Application Publication
(10) Pub. No.: US 2006/0153020 A1
(43) Pub. Date: Jul. 13, 2006

(54) Compact disk musical jukebox with digital music library access

(75) Inventors: James D Johnson, Colchester, VT (US); Jeffrey J Kalis, Rockford, MI (US); Jerry Cantrell, Grand Rapids, MI (US); Roger L Wilson, Grandville, MI (US)

Correspondence Address: DICKSTEIN SHAPIRO MORIN & OSHINSKY LLP, 2101 L Street, NW, Washington, DC, 20037, US

(73) Assignee: Rowe International Corporation, Grand Rapids, MI (US)

(21) Appl. No.: 10/529,439

(22) PCT Filed: Sep. 26, 2003
(86) PCT No.: PCT/US03/30729

§ 371 Date: Nov. 3, 2005

Related U.S. Application Data
(60) Provisional application No. 60/414,229, filed on Sep. 27, 2002.

(51) Int. Cl. G11B 21/08; G11B 7/085

(52) U.S. Cl. 369/30.06

(57) ABSTRACT

A song data downloading system and method of dispensing music are provided for use with a music data server and a musical jukebox. A song selection device and a control are provided. The control is operable to receive a user selection of particular song data with the song selection device. The user selection is made from compact disk song data or downloaded song data. The compact disk song data is from a compact disk that is in the compact disk storage and retrieval system of the jukebox. The downloaded song data is downloaded from a music data server. The control provides the selected song data to the music production system of the jukebox for producing audio from the selected song data. The control discards downloaded song data upon producing audio from the downloaded song data.

### BACKGROUND OF INVENTION

The present invention relates to a jukebox system and jukebox useful therewith.

One form of a musical jukebox is a compact disk (CD) jukebox having a compact disk player and a compact disk storage and retrieval system for storing a large number, such as 100, compact disks. A title rack displays song titles that are available for selection. Upon receiving a user's deposit of money and selection of a song title, the corresponding CD is retrieved and played by the disk player. Compact disk jukeboxes are disclosed in commonly assigned U.S. Pat. Nos. 5,031,346; 5,050,148; 5,704,146; and 6,373,796.

A more recent form of musical jukebox utilizes a microcomputer having a hard drive in order to store the musical song data. The digital song data is kept current by the provisions of remote access downloading capability in order to download digital song data from a remote server. The downloaded songs may be stored on the hard drive for playback at a later time and/or may be downloaded upon demand by a user and played immediately upon download. Examples of such digital downloading jukebox systems are disclosed in U.S. Pat. Nos. 5,341,350; 6,308,204; 6,381,575; 5,691,984; 5,959,945; and International Patent Publication No. WO 01/08148 A1 published Feb. 1, 2001.

Digital downloading jukeboxes are not without their difficulties. In supplying a jukebox to an operator, the hard drive is typically mastered with a music library selected by the operator. This is a time-consuming operation. Additionally, the presence of digital data stored in a non-volatile fashion on the hard drive creates copyright security issues. Another difficulty with digital downloading jukeboxes is the payment of royalties to the company that holds the copyright on the music. This may be accomplished by assigning a portion of the proceeds of the jukebox (known as the “cash box”) to the music supplier. This requires the operator to disclose the content of the cash box to the music supplier, which is sensitive information. In particular, this informs the operator of the music library of the proceeds of each operator operating a jukebox. Another difficulty with digital downloading jukeboxes is that the jukebox quickly becomes inoperative if it is no longer in communication with the server to obtain song title updates.

### SUMMARY OF INVENTION

A song data downloading system and method of dispensing music, according to an aspect of the invention, are provided for use with a music data server and a musical jukebox. The music data server stores server song data of a plurality of songs. The musical jukebox has a compact disk storage and retrieval system, a compact disk player, a production system for producing audio and a credit system for accepting user money. A song selection device and a control are provided. The control is operable to receive a user selection of song data with the song selection device. The selected song data is chosen from compact disk song data or downloaded song data. The compact disk song data is from a compact disk that is in the compact disk storage and retrieval system of the jukebox. The downloaded song data is server song data that is downloaded from the music data server. The control provides the selected song data to the music production system of the jukebox for producing audio from the selected song data. The control discards the downloaded song data upon producing audio from the downloaded song data.

The downloaded song data may be encrypted, or encoded, and/or compressed. If so, a decoder is provided for decoding and/or decompressing the downloaded song data. A search function may be provided for decrypting, searching server song data on the music server by artist or track. The control may be a fully solid-state electronic system including a microprocessor-based controller. A title rack may be provided for displaying song titles of compact disks in the storage and retrieval system. A song catalog may be provided of server song data that is available for downloading. The song catalog may store a unique identifier with each server song data.

A first queue may be provided for identification data of songs selected with the song selection device. A second queue may be provided for identification data of server song data selected with the song selection device. A buffer may be provided for song data being downloaded, for song data that has been downloaded, and/or for song data being converted to audio.

A plurality of song selection devices may be provided and the control may be made up of a plurality of subcontrols, each operable to receive a user selection of the song data with the respective one of the song selection devices. Each of the subcontrols discards the respective downloaded song data upon producing audio from the downloaded song data. A multiplexer may be provided to supply downloaded song data from one of the subcontrols to the music production system. A housing may be provided for each of the song selection device and subcontrol combinations. The subcontrol may be a fully solid-state electronic device and may include a microprocessor-based controller. Each of the subcontrols may include a first and second queue for song identification data and a buffer for downloaded song data. The downloaded song data may be encrypted, or encoded, and/or compressed and each of the subcontrols may include a decoder for decrypting, or decoding, and/or decompressing the downloaded song data.

A music data server may be provided for storing song data of a plurality of songs. The music data server may include an accounting function, which accounts for royalties that are due for the downloaded song data.

These and other objects, advantages, and features of this invention will become apparent upon review of the following specification in conjunction with the drawings.

### BRIEF DESCRIPTION OF DRAWINGS

FIG. 1 is a perspective view of a musical jukebox, according to the invention;

FIG. 2 is a block diagram of a musical jukebox system, according to the invention; and

FIGS. 3a and 3b are a flowchart of a music selection and production process;

FIG. 4 is the same view as FIG. 2 of an alternative embodiment;

FIG. 5 is an illustration of the main menu screen display; and

FIGS. 6a-6f are illustrations of screen displays for locating and playing downloaded song data.

### DETAILED DESCRIPTION OF THE PREFERRED EMBODIMENT

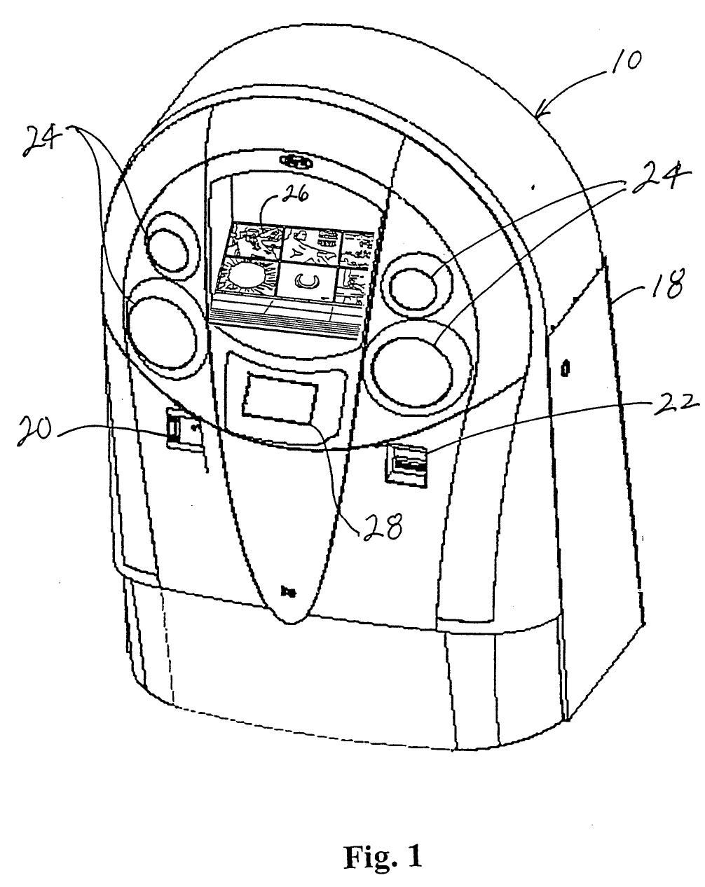

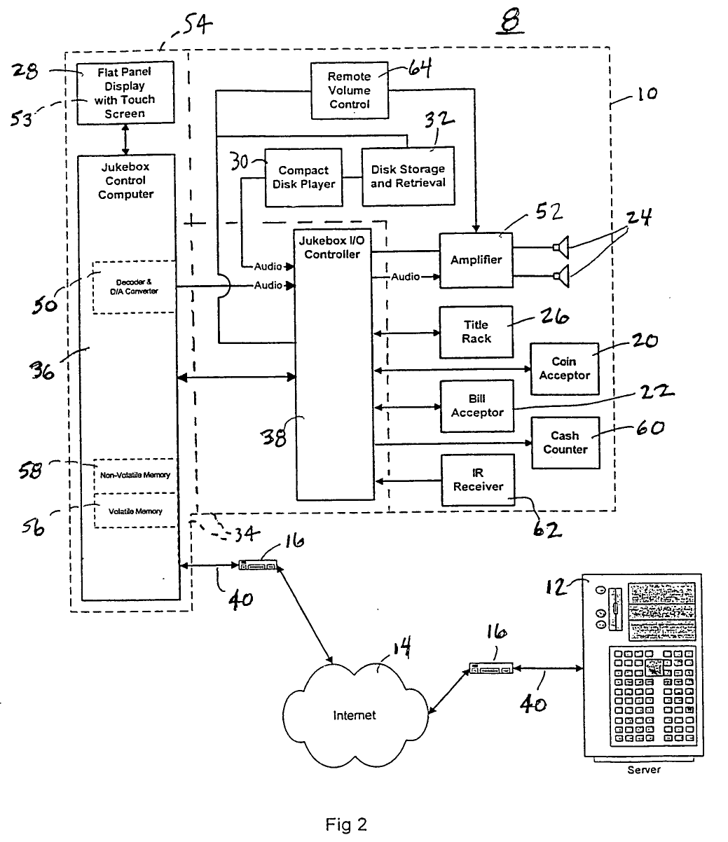

Referring now to the drawings and the illustrative embodiments depicted therein, a musical jukebox system 8 includes one or more musical jukeboxes 10 and a music data server 12 (FIGS. 1 and 2). Music data server 12 may be a single server computer or a plurality of computers connected together as is common in server installations and is well known in the computer industry. Each musical jukebox 10 is in communication with server 12 over a high-speed network connection 14, such as a digital subscriber line (DSL), a high-speed satellite link, or the like. A modem or router 16 interfaces jukebox 10 and server 12 with the high-speed network 14 either directly or through a local-area network 40. Network 40 may be an Ethernet network or use another protocol. In most applications, musical jukebox 10 is located at a significant distance from server 12, but may, in certain applications, be in closer proximity thereto. Furthermore, more than one jukebox 10 may be connected to the network connection with a router 16.

Jukebox 10 includes a cabinet 18, which houses one or more devices used to establish credit, such as a coin acceptor 20, a bill acceptor 22, or other device, such as a credit/debit card acceptor. Jukebox 10 may also include a cash counter 60 to provide a record of coins and bills deposited. Jukebox 10 may also include infrared (IR) receiver 62 or remote volume control 64 to control various jukebox functions, such as volume control, all of which are common in jukebox installations and well known in the jukebox industry. Jukebox 10 includes one or more speakers 24 for reproducing audio output. A compact disk player 30 retrieves music song data from a CD, which is selected from a plurality of CDs stored in a CD storage and retrieval system 32. Disk storage and retrieval system 32 may be of the type commonly used in the industry, such as disclosed in commonly assigned U.S. Pat. Nos. 5,050,148 and 6,373,797, the disclosures of which are hereby incorporated herein by reference.

Jukebox 10 may include title rack 26 for displaying information on musical titles that are available for selection from compact disks (CDs). As is common, the title rack contains a plurality of pages, each of which contains multiple locations for displaying information, such as an insert that typically accompanies a music CD. Title rack 26 may be a vertically hinged title rack, such as disclosed in commonly assigned U.S. Pat. No. 5,031,346, or a horizontally hinged title rack, such as disclosed in commonly assigned U.S. Pat. No. 5,704,146, both of which are hereby incorporated herein by reference.

Jukebox 10 includes a user input selection device and display, which may be combined in a touch screen 28. The touch screen is used for selecting songs as will be described in more detail below. In an illustrated embodiment, a user may select a song from a compact disk stored in CD storage and retrieval system 32 by browsing the titles in the title rack 26 and making a selection with touch screen 28. As is conventional, information about the songs available on the CDs stored in CD storage and retrieval system 32 is displayed in title rack 26. Therefore, to make a selection from among the CDs stored in CD storage and retrieval system 32, a user may enter a number representing the specific CD and track desired using touch screen 28. Advantageously, jukebox control system 34 may access any of a number of public or private databases on high-speed network 14 and obtain the CD title and titles of each song on every CD stored in CD storage and retrieval system 32 and store these titles in non-volatile memory 58 in jukebox control computer 36. Therefore, menu 53 may include a full title for each song stored in this manner or a shorthand code to retrieve a particular song that is desired. Upon selecting a song that is stored on compact disk, I/O controller 38 instructs CD storage and retrieval system 32 to retrieve and deposit an appropriate CD on compact disk player 30 and to select the appropriate track for the CD on compact disk player 30.

Jukebox 10 further includes a control system generally shown at 34, which is made up of a jukebox control computer 36 and a jukebox input and output (I/O) controller 38. Jukebox control computer 36 and I/O controller 38 may be implemented in some form by hardware and software and may be combined in a common microcomputer with control computer 36. In particular, I/O controller 38 may be coded within a common microcomputer with jukebox controller 36. The microcomputer may also be embodied in a fully solid-state electronic module, such as a single board RISC embedded system computer and operating system. Such electronic module may include a power supply, as well as a CPU board and one or more card slots. One slot may be filed with a communication card, such as a PCMCIA card for providing a communication interface, such as with an Ethernet connection bus or with a modem or router 16. The CPU board may include various forms of solid-state memory. Such solid-state memory may include non-volatile memory 58, such as flash memory, as well as volatile memory 56, such as DRAM memory. Computer 36 may include an operating system, such as Windows CE, in which applications may be written in visual C++ or Visual Basic language, all of which are available from Microsoft Corporation.

Jukebox 10 additionally includes a decoder, such as an MP3 hardware decoder, and a digital-to-analog (D/A) converter 50 for decoding music song files and converting the song data to analog signals. It should be understood that the nature of the decoder corresponds to the type of protocol used to encode and/or compress the downloaded song data. Various types of coding and/or compression techniques are available and are being developed. Selection of one is well within the ability of those skilled in the art. Alternatively, decoder and D/A converter 50 may be implemented in software and contained as part of the application or operations system, thus replacing the equivalent hardware. The jukebox further includes an audio stereo amplifier 52, which amplifies the audio signal and supplies it to speakers 24 for producing music audio.

Jukebox control computer 36 defines a song data download system 54 for downloading song data from remote server 12. This is accomplished by a menu 53 displayed on touch screen 28 of the server song data with music data server 12. When the user makes a selection from that menu, song data download system 54 downloads the selected server song data through high-speed network 14 from server 12 through a buffer. When the user makes the selection, a confirmation screen is displayed and, when confirmation is made by the user, the song data is downloaded and the credit established by the user through bill acceptor 22 and coin acceptor 20 is debited accordingly. The song data, which may be in MP3 format or other common format, is decoded and/or decompressed and converted to an analog signal by decoder and D/A converter 50 and played as an audio signal by amplifier 52 and speakers 24. D/A converter 50 may be a separate device or may be defined by controller 38. In the illustrative embodiment, the jukebox control computer does not have a hard drive or other form of memory that can store downloaded music data. Once downloaded song data is played, it is discarded. The song data may be downloaded at substantially the same rate that the song data is converted to audio. Alternatively, one song data may be downloaded while another song data is being converted to audio either from CD song data or downloaded song data. Either way, jukebox system 10 is capable of providing essentially streaming audio selected from a very large number of song artists and titles.

Thus, it is seen that the present invention provides two ways to select music for the user. The user may browse the titles that are available in title rack 26 and select a song from one of the CDs displayed therein. Alternatively, the user may browse a larger menu 53 of song titles that are available on server 12. Should the user choose a song from title rack 26, jukebox control computer 36 by way of I/O controller 38 causes the song track from that CD to be played. Should the user select a song from music server 12, song data download system 54 downloads the song data in a buffer and the song data is produced as an audio output with speakers 24. As previously set forth, when the downloaded song data is converted to audio, the song data is discarded and no downloaded song data is stored in memory. The user may be charged a different fee, such as a higher fee, for downloaded song data.

As song titles are added to server 12, menu 53 may be updated through an upload from the music server 12 to each jukebox. Advantageously, each song data file may include a unique identifier, such as a string of alphanumeric characters, which is also displayed on menu 53. Because the same catalog of song titles is available to each jukebox in system 8, a user may go into a different establishment and enter a unique identification number with touch screen 28 and have the corresponding song downloaded from server 12 without the necessity of browsing the menu. Advantageously, server 12 may retain all song data entered therein in order to avoid disappointing a user who enters a unique identifier to ensure that all identified song data is present.

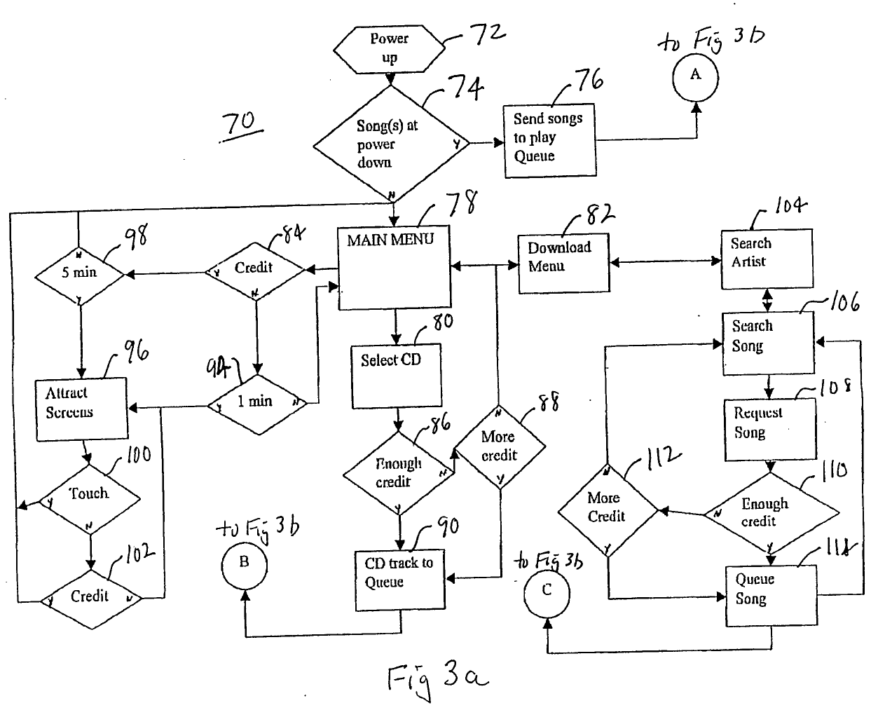

Jukebox system 8 employs a music selection and production process 70 (FIGS. 3a and 3b). When jukebox 10 is powered up at 72, it is determined at 74 whether any song identification remains from prior to power-down the jukebox. If so, song identification is sent to a play queue 92. If it is determined at 74 that there is no remaining song identification, a main menu is accessed at 78. The menu allows a user to select a CD at 80, access a menu for downloading song data at 82 or adding credit at 84. If the user chooses to select a CD at 80, it is determined at 86 whether there is enough credit for the selection. If not, more credit can be added at 88. When credit is sufficient, the user selects a CD at 90 which is added to the song play queue 92.

If the user chooses from the main menu 78 to add credit, it is determined at 84 whether the user has added credit. If not, it is determined at 94 if a minute has passed and, if so, the process returns to an attract screen mode 96. The attract screen mode is for the purpose of providing display 28 with various images in order to attract the attention of potential users to the jukebox. If it is determined at 84 that the user has entered credit, the process waits at 98 for 5 minutes and, after 5 minutes, enters the attract screen mode 96. When in the attract screen mode 96, the process determines at 100 whether a user has touched the screen and, if so, returns to the main menu 78. If not, the process awaits 102 to the entry of further credit.

When the user enters the download menu at 82, the user is provided the ability to search for artists at 104 or to search for songs at 106. The system displays the artists and songs from the file of artists and songs downloaded from server 12. When the user makes a selection at 108, it is determined at 110 whether sufficient credit is available. The user may be charged more to play downloaded songs than songs retrieved from a CD. If sufficient credit is not available, more credit can be added at 112. If it is determined at 112 that sufficient credit is available, the selected song is added to the song queue (114, 92).

With a song identification added to song play queue 92 that is selected from a CD track, it is determined at 116 whether the CD player is available. If it is, it is determined at 118 whether the next song to be played is from downloaded song data. If not, the selected CD is retrieved by disk storage and retrieval system 32 and played by a compact disk player 30.

With a song identification added to song play queue 92 that is a downloaded song request, that song identification is added to a digital download queue 122. Song downloader 124 responds to the earliest song identification in the download queue by downloading song data for that song from music data server 12 over high-speed network 14. Song downloader 124 is a buffer to receive the song data being downloaded. In the illustrative embodiment, song downloader 124 holds the song data being downloaded, the song data that has been fully downloaded and the song data being decrypted. When the download is complete, the downloaded song data is decoded, decrypted, and/or decompressed at 126. It is then determined at 128 whether a downloaded song data is available for conversion to audio. If it is, it is sent to jukebox I/O controller 38 for processing as audio. If it is determined at 128 that a downloaded song is not ready, it is determined at 130 whether a CD song identification is in the play queue. If so, the selected CD track is retrieved and sent to the CD player 30. If there is no CD song identification in the queue, the control waits at 128 for the download of song data to be complete.

Thus, it is seen that music selection and production process 70 includes a first queue 128 for identification of selected songs and a second queue 122 for identification of songs to be downloaded from music server 12. Music section and production process 70 further includes a buffer 124 for downloaded song data that is being decrypted and converted to audio for downloaded song data awaiting to be converted to audio and for song data being downloaded. It should be understood that a greater or fewer number of queues and buffer spaces may be provided. For example, if the song data is downloaded at the same rate as the downloaded song data is converted to audio, at least one buffer space could be eliminated.

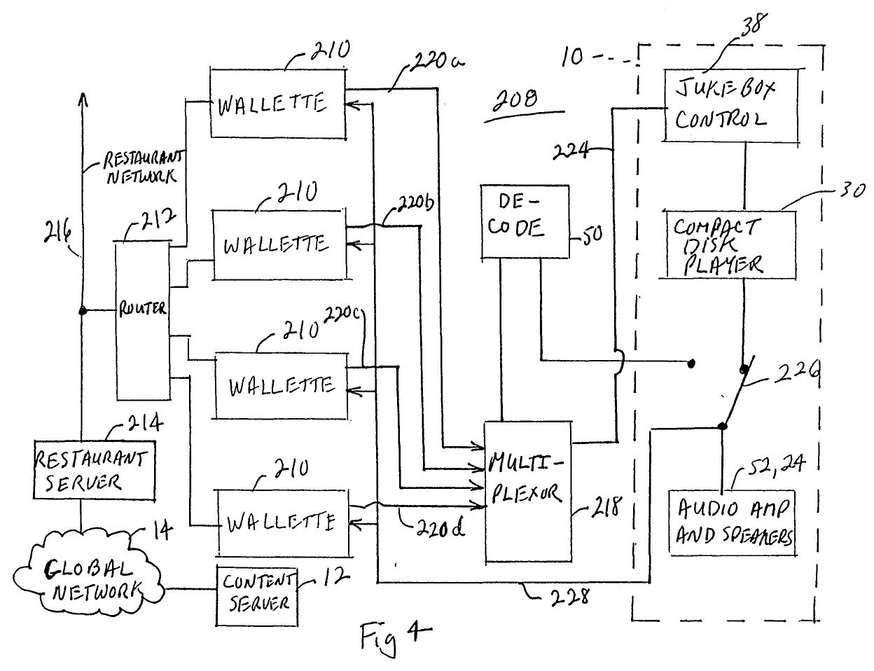

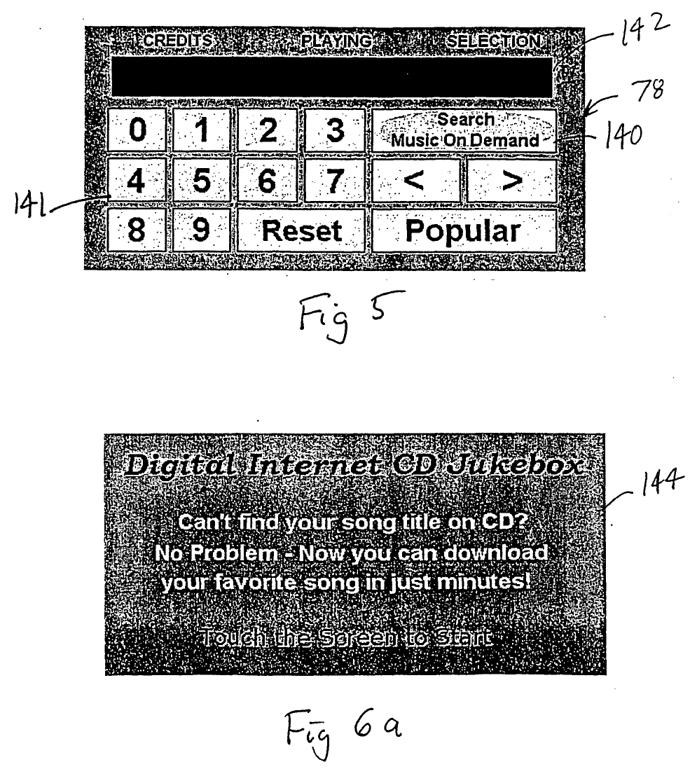

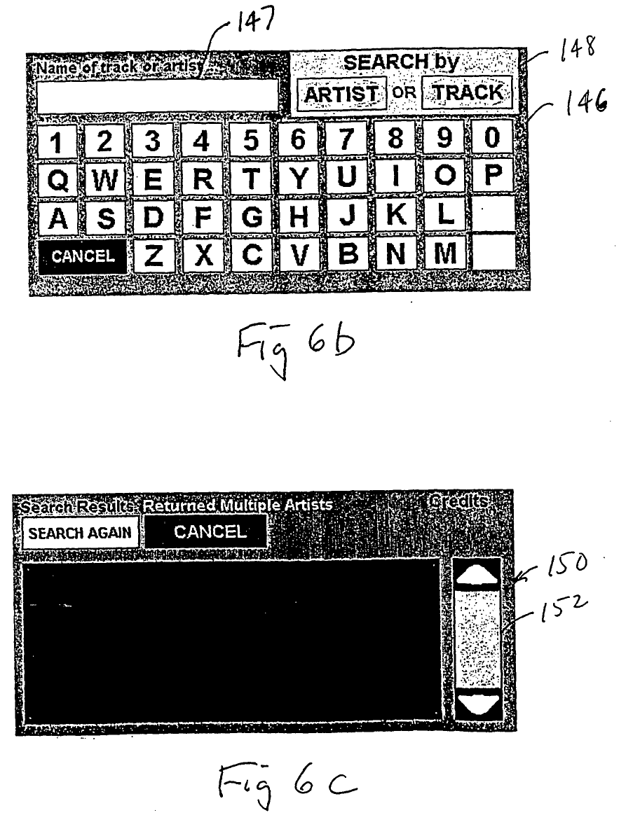

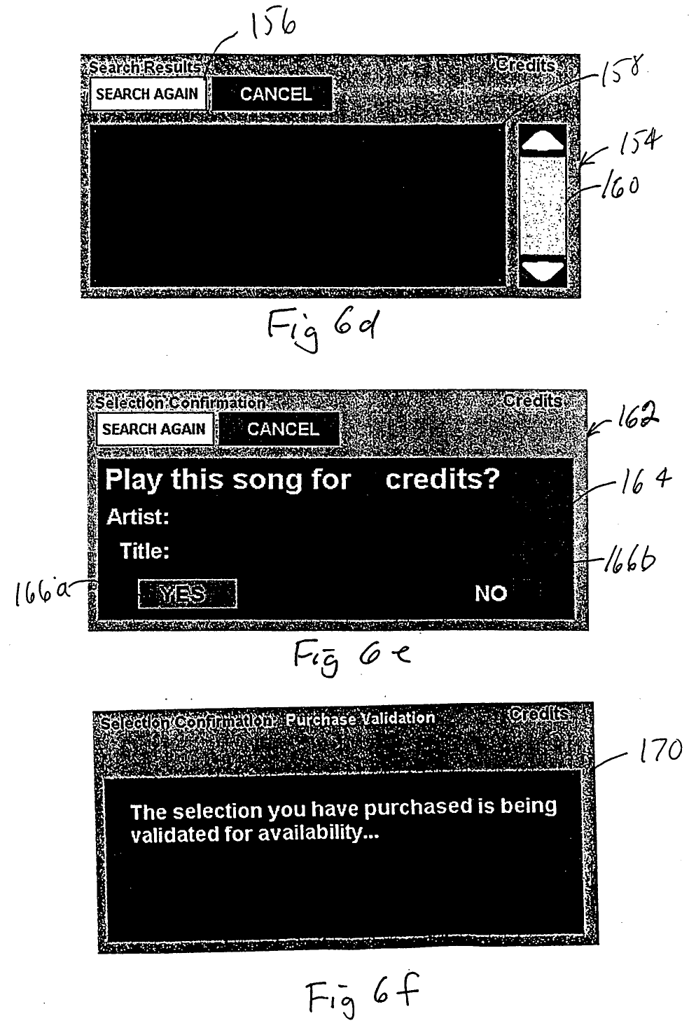

FIG. 5 illustrates an example of a display for main menu 78. From main menu 78, a CD selection can be made by entering the four-digit code found in title rack 26 for the CD jacket and song on the CD using a touch keypad 141. Also, pressing a “search music on demand” selection 140 will allow the user to select from song menus of music on server 12. A display area 142 allows display of the amount of credits available, the song that is playing as well as a selection that is being made. FIG. 6a illustrates a song download attract screen 144. One purpose of screen 144 is to attract the user to the machine and the fact that the user is not limited to the songs on the CD title rack. Screen 144 could also be used to advertise a product and/or service. When a user touches screen 144, a search screen 146 is displayed (FIG. 6b). Screen 146 is the main download search screen. By entering an alphanumeric string, an artist or song title can be searched from the song catalog. The song catalog is stored in memory of the jukebox and, in the illustrated embodiment, is downloaded from server 12. The alphanumeric string is typically only the start of the whole word for better and quicker searches. Screen 146 provides a selection area 148 for selecting whether the search is to be by artist or by track. A display area 147 displays the entry being made by the user.

Following the search screen 146, the results are displayed on a results display screen 150 (FIG. 6c). This is the artist search result screen which would contain up to four artists from which to pick the songs to be displayed. If more than four artists are located, a scroll bar 152 is provided which will allow searching of the rest of the list. A song result screen 154 is displayed if the search is by song track (FIG. 6d). The results of the search can come from the main download search screen or is a result of an artist selection from screen 150. It will have the artist name behind the “search results” display 156 and up to four song titles in box 158. If more than four songs match the search inquiry, the user uses a scroll button 160 to allow searching of the rest of the list.

After a song from the search screen 154 has been selected, a selection confirmation screen 162 is displayed (FIG. 6e). Display 162 displays at 164 the artist and title selected and provides selection buttons 166a, 166b that allow the user to accept or decline the selection. If the user accepts the selection, a purchase validation screen 170 is displayed (FIG. 6f). If the selection is validated, the song is downloaded to download queue 124. If the search is not validated, the user is informed and is allowed to make further selections.

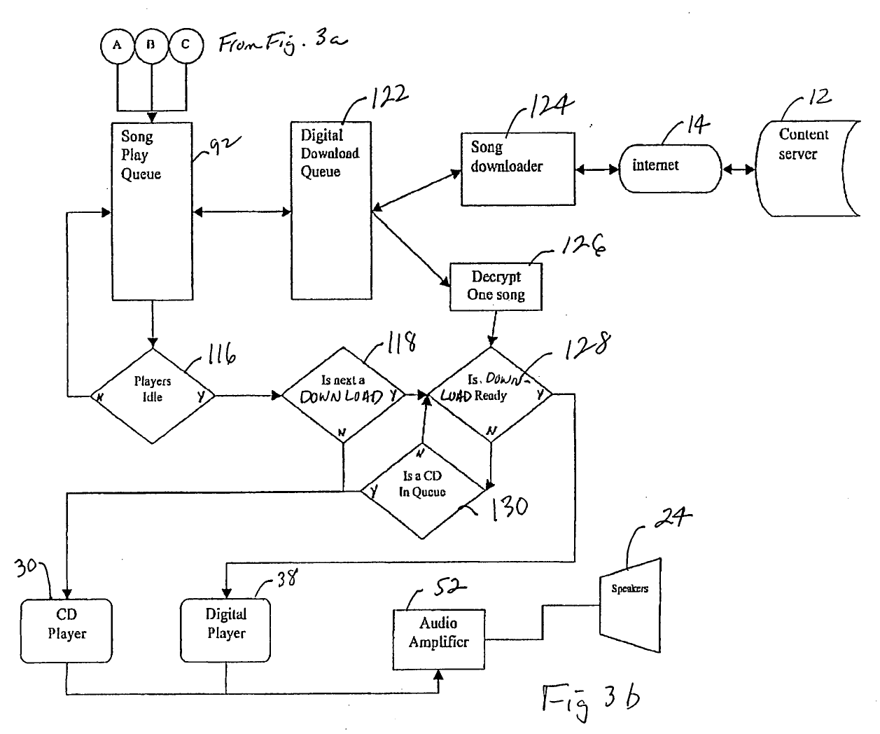

In an alternative embodiment, a musical jukebox system 208 includes a musical jukebox 10 and a plurality of Wallette units 210 (FIG. 4). System 208 is especially suitable for use in a restaurant, but may have other applications. Wallette unit 210 is a standalone unit, which, typically, is associated with a table or booth and provides the ability for a user at that table or booth to select and listen to music either from CD player 30 or downloaded from server 12. Each Wallette unit 210 includes song data downloading system 54, including a flat panel display 28 with touch screen 53 and a control computer 36. Wallette unit 210 may also include an amplifier 52 and one or more speakers 24. All components may be enclosed in a housing (not shown), which may be sufficiently small to be mounted to a wall adjacent to a dining table in the establishment. Each Wallette unit 210 may be connected through a router 212 to high-speed digital network 14 either directly or through a server 214 that serves a restaurant network 216. Each Wallette 210 is capable of downloading and buffering song data from content server 112. As such, each Wallette unit 210 includes a song play queue 92, digital download song queue 122 and a song downloader 124.

A multiplexer 218 is interconnected with each Wallette unit 210, such as through a link 220a-220d. Link 220a-220d may be digital bus, or the like. An output of multiplexer 218 is supplied to a jukebox control through a link 224. Multiplexer 218 provides data, including downloaded song data as well as instructional data, from one Wallette at a time to jukebox control 38. The instructional data may include selection of a CD track to be played by compact disk player 30 as well as other control data. A software function, that could be carried out by jukebox control 38 and is schematically represented at 226, selectively supplies either decoder 50 or compact disk player 30 to audio amplifier 52 and speakers 24. The audio signal may also be supplied by a link 228 to the Wallette units 210 for production on their respective amplifier 52 and speakers 24.

In addition to downloading songs from content server 12 and selecting CD tracks to be played by compact disk player 30, the touch screen of each Wallette unit 210 may provide the ability for communication with other functions within the restaurant, such as through restaurant server 210 and network 216. For example, a user may be provided with a menu of food items and/or beverage items for selection and may be allowed to place food and/or beverage orders through the touch screen. Likewise, the user may be provided with a “call waitress” button to allow the waitress to be called.

Musical jukebox systems 8 and 208 may be manufactured as a unit. Alternatively, they may be supplied as a kit and field retrofitted to an existing jukebox 10. Various changes will be apparent to those skilled in the art. For example, Wallette unit 210 may be a simple input/output device with a separate computer common to all Wallette units 210 for connection to high-speed network 14 for downloading song data for jukebox 10.

It can be seen that the present invention has many advantages over the prior art. All accounting for downloaded song data may be accomplished at server 12. Because each downloaded song is played once and only once, the downloaded data provides per-play information. This information may be provided to the music supplier in order to provide appropriate royalties on a pay-per-play basis. Also, this information may be accessed on-line by the operator of each jukebox in order to inform the jukebox operator of the royalties that are to be paid to the music supplier as well as to inform the operator of the popularity of the songs being played.

Title rack 32 may be updated in a traditional fashion using traditional distributors who are paid by the operator. In this manner, the traditional distributor does not get eliminated from the system, as in the case of digital downloading jukeboxes. Therefore, the distributors have an incentive to support musical jukebox system 8. Moreover, the operator is not required to supply sensitive cash box information to third parties, such as a system operator. Moreover, should an interruption occur in the high-speed network, jukebox 10 can continue to be operated in a conventional fashion with music updated by updating the CDs in the jukebox.

Thus, it is seen that the present invention provides all of the advantages of a traditional compact disk jukebox while providing the user access to a substantially expanded range of music from which to select. The user can be expected to pay additional funds for access to that expanded range of music. The jukebox operator is satisfied because of the ease of operation of the system, which resembles traditional CD jukeboxes and without the necessity for either the complicated accounting procedure used with digital downloading jukeboxes or the necessity to share sensitive cash box information with third parties. The music suppliers are satisfied with the enhanced security because their copyrighted song data is not stored on permanent storage at the jukebox from which illegal copies could be made. The downloaded song data is retained at server 12 and all downloads are both accounted for and discarded after each play.

Moreover, the present invention provides a simpler and more reliable hardware scheme than a conventional downloading digital jukebox. By utilizing an all solid-state electronics module, the necessity of a failure prone hard drive is eliminated. Furthermore, any cost increase vis-à-vis a conventional CD jukebox, such as the need for an all-electronic solid-state control, may be at least partially offset by the elimination of a traditional keypad used with a traditional CD jukebox.

Changes and modifications in the specifically described embodiments can be carried out without departing from the principles of the invention which is intended to be limited only by the scope of the appended claims, as interpreted according to the principles of patent law including the doctrine of equivalents.

The embodiments of the invention in which an exclusive property or privilege is claimed are defined as follows:

1. A song data downloading system for use with a music data server and a musical jukebox, said music data server storing server song data of a plurality of songs, said musical jukebox having a compact disk storage and retrieval system, a compact disk player, a music production system for producing audio, and a credit system for accepting user money, said song data downloading system comprising:
a song selection device;
a control, said control operable to receive a user selection of song data with said song selection device, the selected song data being chosen from compact disk song data or downloaded song data, said compact disk song data being of a compact disk that is in the compact disk storage and retrieval system of the jukebox, said downloaded song data being server song data that is available to be downloaded from the music data server;
said control adapted to provide the selected song data to the music production system and producing audio from the selected song data; and
said control discarding downloaded song data upon producing audio from the downloaded song data.

2. The system of claim 1 wherein the downloaded song data is encoded.

3. The system of claim 2 including a decoder for decoding downloaded song data.

4. The system of claim 1 including a search function, said search function for searching server song data on the music data server by artist.

5. The system of claim 1 including said search function for searching song data on the music data server by track.

6. The system of claim 1 wherein said control comprises a fully solid-state electronic system.

7. The system of claim 6 wherein said control comprises a microprocessor-based controller.

8. The system of claim 7 wherein said song selection device comprises said control.

9. The system of claim 7 wherein said song selection device comprises a touch screen display.

10. The system of claim 6 wherein said electronic system comprises a touch screen display, a controller, and solid-state memory.

11. The system of claim 6 excluding a hard drive for storing downloaded song data.

12. The system of claim 1 including a title rack for displaying song titles of compact disks in said storage and retrieval system.

13. The system of claim 1 including a song catalog of server song data available to be downloaded.

14. The system of claim 13 wherein said song catalog stores a unique identifier with each server song data.

15. The system of claim 1 including a first queue for identification data of songs selected with said song selection device.

16. The system of claim 15 including a second queue for identification data of server song data selected with said song selection device.

17. The system of claim 1 including a buffer for song data being downloaded.

18. The system of claim 17 wherein said buffer is also for song data that has been downloaded.

19. The system of claim 17 wherein said buffer is also for song data being converted to audio.

20. The system of claim 1 including a plurality of said song selection devices, said control including a plurality of subcontrols, each operable to receive a user selection of said song data with a respective one of said song selection devices, each of said subcontrols adapted to discarding the respective downloaded song data upon producing audio from the downloaded song data.

21. The system of claim 20 including a multiplexer, said multiplexer supplying downloaded song data from one of said subcontrols to said music production system.

22. The system of claim 20 including a housing for each of said song selection devices and respective one of said subcontrols.

23. The system of claim 20 wherein each of said subcontrols comprises a fully solid-state electronic system.

24. The system of claim 23 wherein each of said subcontrols comprises a microprocessor-based controller.

25. The system of claim 20 wherein each of said subcontrols includes a first queue for identification data of songs selected with the respective said song selection devices, a second queue for identification data of server song data selected with the respective said song selection device, and a buffer for song data being downloaded.

26. The system of claim 20 wherein the downloaded song data is encoded and wherein each of said subcontrols comprises a decoder for decoding downloaded song data.

27. The system of claim 1 in combination with a music data server for storing server song data of a plurality of songs, wherein said downloaded song data is server song data that is downloaded by said jukebox from said music data server.

28. The system of claim 27 in combination with a musical jukebox having a compact disk storage and retrieval system, a compact disk player, a music production system for producing audio and a credit system for accepting user money.

29. The system of claim 27 wherein said music data server includes an accounting function.

30. The system of claim 29 wherein said accounting function accounts for royalties that are due for downloaded song data.

31. The system of claim 1 in combination with a musical jukebox having a compact disk storage and retrieval system, a compact disk player, a music production system for producing audio and a credit system for accepting user money.

32. A method of dispensing music, comprising:
providing a music data server and storing server song data of a plurality of songs with said music data server;
providing at least one jukebox, said at least one jukebox having a compact disk storage and retrieval system, a compact disk player, a music reproduction system, a song data download system and credit system for accepting user money;
providing a song selection device;
receiving a user selection of song data with said song selection device, the selected song data being chosen from compact disk song data or downloaded song data, said compact disk song data of a compact disk that is in said storage and retrieval system, said downloaded song data being server song data that is available to be downloaded from said music data server;
providing the selected song data to the music production system and producing audio from the selected song data; and
discarding downloaded song data upon producing audio from the downloaded song data.
